(19) United States
(12) Patent Application Publication
(10) Pub. No.: US 2010/0092682 A1
(43) Pub. Date: Apr. 15, 2010

(54) Method for Fabricating a Heater Capable of Adjusting Refractive Index of an Optical Waveguide

(75) Inventors: Daniel N. Carothers, Oro Valley, AZ (US); Craig M. Hill, Warrenton, VA (US); Andrew T.S. Pomerene, Leesburg, VA (US); Thomas J. McIntyre, Nokesville, VA (US); Timothy J. Conway, Gainesville, VA (US); Jonathan N. Ishii, Fredericksburg, VA (US)

Correspondence Address: BAE SYSTEMS, PO BOX 868, NASHUA, NH, 03061-0868, US

(73) Assignee: BAE SYSTEMS INFORMATION AND ELECTRONIC SYSTEMS INT, Nashua, NH (US)

(21) Appl. No.: 12/521,855

(22) PCT Filed: Aug. 29, 2008
(86) PCT No.: PCT/US2008/074718

§ 371 Date: Jun. 30, 2009

Related U.S. Application Data
(60) Provisional application No. 61/000,345, filed on Oct. 24, 2007.

(51) Int. Cl. B05D 3/02

(52) U.S. Cl. 427/383.3

(57) ABSTRACT

A method for fabricating a thermal optical heating element capable of adjusting refractive index of an optical waveguide is disclosed. A silicon block is initially formed on a cladding layer on a silicon substrate. The silicon block is located in close proximity to an optical waveguide. A cobalt layer is deposited on the silicon block. The silicon block is then annealed to cause the cobalt layer to react with the silicon block to form a cobalt silicide layer. The silicon block is again annealed to cause the cobalt silicide layer to transform into a cobalt di-silicide layer.

### PRIORITY CLAIM

The present application claims benefit of priority under 35 U.S.C. §365 to the previously filed international patent application number PCT/US08/074718 filed on Aug. 29, 2008, assigned to the assignee of the present application, and having a priority date of Oct. 24, 2007, based upon United States provisional patent application number 61/000,345. The contents of both applications are incorporated herein by reference.

### STATEMENT OF GOVERNMENT INTEREST

The present invention was made with United States Government assistance under Contract No. HR0011-05-C-0027 awarded by Defense Advanced Research Projects Agency (DARPA). The United States Government has certain rights in the present invention.

### BACKGROUND OF THE INVENTION

1. Technical Field

The present invention relates to optical waveguides in general, and in particular to a method for fabricating a heater capable of adjusting index of refraction of an optical waveguide.

2. Description of Related Art

Planar lightwave circuits (PLCs) generally involve the provisioning of a series of embedded optical waveguides upon a semiconductor substrate with the optical waveguides fabricated from one or more silica glass layers formed on the semiconductor substrate. A conventional optical waveguide includes an undoped silica bottom cladding layer, with at least one waveguide core formed thereon, and a top cladding layer covering the waveguide core. A certain amount of dopant(s) is added to both the waveguide core and the cladding layers so that the refractive index of the waveguide core is higher than those of the cladding layers. The waveguide core is typically doped with germanium to increase its refractive index. As a result, optical signals are confined axially within the waveguide core and propagate lengthwise through the waveguide core.

In many types of PLC devices, a large number of waveguide cores are used to implement complex fiber-optic functions, such as arrayed waveguide grating multichannel multiplexers and de-multiplexers. Exact control of the effective refractive index, which is comprised of core and clad refractive index, is very critical to PLC devices. For example, the center wavelength of each channel in an arrayed waveguide grating (AWG) device is directly affected by the refractive index of the waveguide core. A deviation of refractive index within 0.0001 will cause the channel center wavelength to vary in the region of 0.1 nm. For a 40 channel AWG operating in the C band (˜1520 nm-1565 nm), the channel-to-channel spacing is only 0.8 nm. Therefore, the effective refractive index has to be accurate to about 0.0003 across the substrate in order to yield a high quality AWG device.

When using conventional fabrication processes, core refractive index control is limited to about ±0.0001. Such fabrication limitation restricts the amount of channel isolations that can be obtained in a dense wavelength division multiplexing application, and thus limit the number of channels that can be implemented.

Consequently, it would be desirable to provide a method for fabricating an apparatus capable of adjusting refractive index of a waveguide core.

### SUMMARY OF THE INVENTION

In accordance with a preferred embodiment of the present invention, a silicon block is formed on a cladding layer on a silicon substrate. The silicon block is located in close proximity to an optical waveguide. A cobalt layer is deposited on the silicon block. The silicon block is then annealed to cause the cobalt layer to react with the silicon block to form a cobalt silicide layer. The silicon block is again annealed to cause the cobalt silicide layer to transform into a cobalt di-silicide layer.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIGS. 1-5 are diagrams illustrating the successive steps of a method for fabricating an apparatus capable of adjusting refractive index of an optical waveguide, in accordance with a preferred embodiment of the present invention.

### DETAILED DESCRIPTION OF A PREFERRED EMBODIMENT

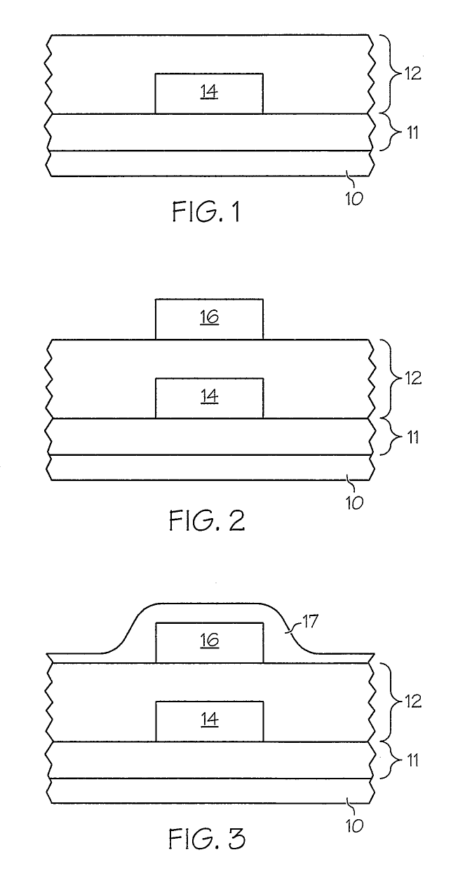

Referring now to the drawings and in particular to FIGS. 1-5, there are illustrated successive steps of a method for fabricating an apparatus capable of adjusting refractive index of an optical waveguide, in accordance with a preferred embodiment of the present invention. The method of the present invention begins with an optical waveguide 14 embedded within a bottom cladding layer 11 and a top cladding layer 12, as shown in FIG. 1. Both cladding layers 11 and 12, which are preferably made of silicon dioxide, are located on a substrate 10 preferably made of silicon.

Next, an amorphous (or polycrystalline) silicon block 16 is formed on top cladding layer 12, as depicted in FIG. 2. Amorphous silicon block 16 is preferably formed by utilizing a photolithographic pattern and etching techniques that are well-known in the art. Preferably, amorphous silicon block 12 is approximately 2,000 Å thick.

A cobalt layer 17 is then deposited on top cladding layer 12 covering amorphous silicon block 16, as shown in FIG. 3. Preferably, cobalt layer 17 is approximately 150 Å thick. Although cobalt is utilized to illustrate the present invention, cobalt can be substituted with nickel or titanium.

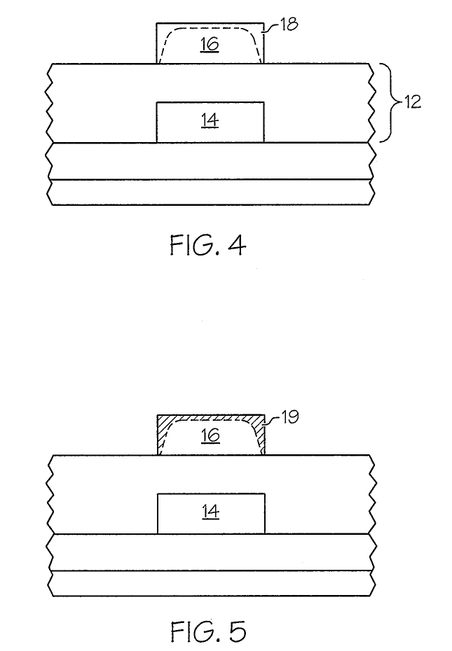

An initial annealing process is then applied to substrate 10 at preferably 750 ° C., during which cobalt layer 17 reacts with amorphous silicon block 16 to form a cobalt silicide (CoSi) layer 18, as depicted in FIG. 4. Any unreacted cobalt from cobalt layer 17 is removed by utilizing a wet etch technique that is well-known in the art.

A second annealing process is then applied to substrate 10 at preferably 850 ° C. to transform CoSi layer 18 to a cobalt di-silicide (CoSi₂) layer 19, as shown in FIGS. 5.

CoSi₂ layer 19 can be utilized as a thermal resistive heating element for adjusting refractive index of optical waveguide 14 located adjacent to CoSi₂ layer 19. For example, electrical current can be applied to CoSi₂ layer 19 via respective vias and contacts in order heat up CoSi₂ layer 19. The refractive index of optical waveguide 14 can be changed according to the temperature of CoSi₂ layer 19 (i.e., magnitude of applied current).

The thermo-optic effect is the thermal modulation of the refractive index of optical waveguide 14. The refractive index of optical waveguide 14 can be modulated as a function of its thermo-optic coefficient α. By heating optical waveguide 14, a change in the lattice parameter changes the electron density and the shape of the lattice potential. In turn, this will affect the dielectric constant.

As has been described, the present invention provides a method for fabricating a cobalt di-silicide heater capable of adjusting refractive index of an optical waveguide. The cobalt di-silicide heater of the present invention is a refractory thermally resistive heater element that allows for robust control of for example, multichannel multiplexers and de-multiplexers. The thermal energy from the cobalt silicide heater can change the refractive index of a selected area of the optical waveguide, thereby changing the optical path length of the filter section. This, in turn, changes the phase match with other optical waveguides filter sections.

While the invention has been particularly shown and described with reference to a preferred embodiment, it will be understood by those skilled in the art that various changes in form and detail may be made therein without departing from the spirit and scope of the invention.

What is claimed is:

1. A method for manufacturing a heater for adjusting index of refraction of an optical waveguide, said method comprising:
forming a silicon block on a cladding layer on a substrate, wherein said silicon block is located in close proximity to an optical waveguide;
depositing a metal layer on said silicon block; and
annealing said silicon block to cause said metal layer to react with said silicon block to form a silicide layer.

2. The method of claim 1, wherein said method further includes annealing said silicon block to cause said cobalt layer to transform into a cobalt di-silicide layer.

3. The method of claim 1, wherein said silicon block is made of amorphorus silicon.

4. The method of claim 1, wherein said silicon block is made of polycrystaline silicon.

5. The method of claim 1, wherein said silicon block is approximately 2,000 Å thick.

6. The method of claim 1, wherein said cladding layer is made of silicon dixode.

7. The method of claim 1, wherein said metal layer is made of cobalt.

8. The method of claim 1, wherein said metal layer is made of nickel.

9. The method of claim 1, wherein said metal layer is made of titanium.

10. The method of claim 1, wherein said metal layer is approximately 150 Å thick.
